(19) United States
(12) Patent Application Publication
(10) Pub. No.: US 2023/0113402 A1
(43) Pub. Date: Apr. 13, 2023

(54) ROTARY LATCH FOR PORTHOLE DOOR OF AN INCUBATOR

(71) Applicant: GE Precision Healthcare LLC, Wauwatosa, WI (US)

(72) Inventors: Helge B. Klockow, Wauwatosa, WI (US); Mohanavenkatesh Thangavelu, Bangalore (IN); Shahasan Noushad, Waukesha, WI (US); Steven M. Falk, Laurel, MD (US); Lothar Mitzlaff, Lagos (PT); Hendrik Hug, Sindelfingen (DE); Jan Rheinländer, Herrenberg (DE); Arne Kurz, Boblingen (DE); Michael Schlag, Gartringen (DE); Andreas Dreher, Ammerbuch (DE)

(73) Assignee: GE Precision Healthcare LLC, Wauwatosa, WI (US)

(21) Appl. No.: 17/500,263

(22) Filed: Oct. 13, 2021

(51) Int. Cl. E05C 3/04; A61G 11/00; E05C 3/00

(52) U.S. Cl. CPC E05C 3/046; A61G 11/006; E05C 3/004

(57) ABSTRACT

A neonatal incubator system includes an enclosure having a series of side panels that create a chamber that receives an infant. At least one of the side panels includes a porthole having a porthole door that is movable between open and closed positions. A rotary latch is positioned to engage the porthole door to retain the porthole door in the closed position when the latch is in a latched position. The rotary latch is designed such movement of the rotary latch to an unlatched position creates physical separation between the porthole door and a sealing gasket or bumpers located between the porthole door and the side panel. The rotary latch is designed such that a control knob can be moved to a cleaning position in which the control knob is spaced from the side panel to expose a liquid gutter that is formed as part of a stationary base.

### BACKGROUND

The present disclosure generally relates to neonatal care systems, and more specifically to a rotary latch for securing a porthole door of an enclosure of the neonatal care system.

Some neonates are not physiologically well enough developed to be able to survive without special medical attention. A frequently used medical aid for such infants is the incubator. The primary objective of the incubator is to provide an environment which will maintain the neonate at a minimum metabolic state thereby permitting as rapid physiological development as possible. Neonatal incubators create a microenvironment that is thermally neutral where a neonate can develop. These incubators typically include a humidifier and a heater and associated control system that controls the humidity and temperature in the neonatal microenvironment. The humidifier comprises a device that evaporates an evaporant, such as distilled water, to increase relative humidity of air within the neonatal microenvironment. The humidifier is typically controllable such that the amount of water, or water vapor, added to the microenvironment is adjustable in order to control the humidity to a desired value. The heater may be, for example, an air heater controllable to maintain the microenvironment area to a certain temperature. Radiant warmers may be used instead of incubators for some neonates where less environmental control is required. In still other embodiments, hybrid incubator/radiant warming systems may be utilized, various embodiments of which are well known in the art.

Since the microenvironment is accurately controlled in a neonatal care system, the care system includes an enclosure that is sealed as best possible to help maintain the controlled microenvironment. Such enclosure will typically include one or more portholes that allow a caregiver to have access to the infant and equipment within the enclosure. The porthole can include a porthole door that can be opened and closed as desired. In some care systems, a flexible gasket surrounds the porthole opening to the enclosure and engages the porthole door when the porthole door is in the closed position. A rotary latch is provided to secure the porthole door in the closed position.

### SUMMARY

This Summary is provided to introduce a selection of concepts that are further described below in the Detailed Description. This Summary is not intended to identify key or essential features of the claimed subject matter, nor is it intended to be used as an aid in limiting the scope of the claimed subject matter.

A neonatal incubator system for use with an infant includes an enclosure that creates a chamber that is designed to receive the infant. The enclosure is formed from a plurality of side panels where at least one of the side panels includes at least one porthole. The porthole provides a point of access for a caregiver to reach into the chamber through the side panel when the side panel is in an upright, closed position. The porthole includes a porthole door that is movable between open and closed positions. When the porthole door is in the closed position, the porthole door engages a sealing gasket in some embodiments.

A rotary latch is positioned to engage the porthole door to hold the porthole door in the closed position when the rotary latch is in a latched position. When the rotary latch moves from the latched position to an unlatched position, the rotary latch is designed to cause the porthole door to move away from the closed position. Such movement of the porthole door upon movement of the rotary latch creates separation between the porthole door and the sealing gasket.

In one exemplary embodiment, a bias spring is included in the rotary latch to bias the rotary latch into the latched position. The bias spring urges a control knob of the rotary latch toward a home, latched position. The control knob is rotatable in both a clockwise and a counterclockwise direction to move the control knob from the latched position to one of two unlatched positions.

In one exemplary embodiment, the control knob is movable away from a stationary base of the rotary latch to allow for cleaning when the rotary latch is attached to the side panel. The stationary base of the rotary latch includes a liquid gutter that is formed to limit the passage of liquid and contaminants into the control knob during use of the rotary latch. The control knob is movable relative to the base when the control knob is rotated to a cleaning position. In one contemplated embodiment, the control knob rotates past the unlatched position before reaching the cleaning position.

Another embodiment of the present disclosure is directed to a rotary latch designed for use with a neonatal incubator system that includes an enclosure that creates a chamber around an infant. The enclosure includes a plurality of side panels where at least one side panel includes a porthole and an associated porthole door. The porthole door is movable between a closed position and an open position. In one contemplated embodiment, a sealing gasket surrounds the porthole and engages the porthole door when the porthole door is in the closed position. The rotary latch includes a stationary base that has a contact surface that contacts the side panel. A control knob is received on the base and is rotatable about the base between a latched position and an unlatched position. A bias spring is positioned between the base and the control knob to bias the control knob toward the latched position. When the rotary latch rotates from the latched position to the unlatched position, the rotary latch is configured to contact the porthole door and move the porthole door away from the closed position. This movement separates the porthole door from the sealing gasket in embodiments in which a sealing gasket surrounds the porthole. In other embodiments, the movement may separate the porthole door from other elastomer elements, such as bumpers are stops that contact the porthole door in the closed position.

In one exemplary embodiment, the control knob is movable away from a stationary base to allow for cleaning when the rotary latch is attached to the side panel. The stationary base includes a liquid gutter that is formed to limit the passage of liquid and contaminants into the control knob during use of the rotary latch. The control knob is movable relative to the base when the control knob is rotated to a cleaning position. In one contemplated embodiment, the control knob rotates past the unlatched position before reaching the cleaning position.

Various other features, objects, and advantages of the invention will be made apparent from the following description taken together with the drawings.

### BRIEF DESCRIPTION OF THE DRAWINGS

The drawings illustrate the best mode presently contemplated of carrying out the disclosure. In the drawings:

FIG. 1A is a perspective view of an exemplary neonatal incubator system in accordance with one embodiment of the present disclosure;

FIG. 1B is a perspective view of another exemplary neonatal incubator system with one of the side panels of the enclosure folded into an access position;

FIG. 2 is a perspective view of a porthole door held in a closed position by an exemplary rotary latch of the present disclosure;

FIG. 3 is an exploded view of the porthole door and rotary latch shown in FIG. 2;

FIG. 4 is an exploded view of an exemplary embodiment of the rotary latch of the present disclosure;

FIG. 5 is a top view showing the rotary movement of the rotary latch in a first direction;

FIG. 6 is a top view showing the rotary movement of the rotary latch in a second direction;

FIG. 7 is a side view of the rotary latch in an operative position;

FIG. 8 is a side view of the rotary latch in a cleaning position;

FIG. 9 is a top perspective view of the spring case that forms part of the rotary latch of the exemplary embodiment;

FIG. 10 is a bottom perspective view of the spring case that forms part of the rotary latch of the exemplary embodiment;

FIG. 11 is a top perspective view of the base that forms part of the rotary latch of the exemplary embodiment;

FIG. 12 is a bottom perspective view of the base that forms part of the rotary latch of the exemplary embodiment;

FIG. 13 is a perspective view of the base of the rotary latch of the exemplary embodiment;

FIG. 14 is a top perspective view of the control knob that forms part of the rotary latch of the exemplary embodiment of the present disclosure;

FIG. 15 is a front view of the control knob that forms part of the rotary latch of the exemplary embodiment of the present disclosure;

FIG. 16 is a front view of the rotary latch in the latched position and holding the porthole door in the closed position;

FIG. 17 is a section view of the rotary latch in the latched position and holding the porthole door in the closed position;

FIG. 18 is a front view the rotary latch in the unlatched position that moves the porthole door away from the closed position; and

FIG. 19 is a section view the rotary latch in the unlatched position that moves the porthole door away from the closed position.

The drawings illustrate specific aspects of the described components, systems and elements of a neonatal care system. Together with the following description, the drawings demonstrate and explain the principles of the structures, methods, and principles described herein. In the drawings, the thickness and size of components may be exaggerated or otherwise modified for clarity. Well-known structures, materials, or operations are not shown or described in detail to avoid obscuring aspects of the described components, systems and methods.

### DETAILED DISCLOSURE

The inventors have recognized a problem with current incubator systems for neonatal care, which is that many incubator systems have porthole doors that can stick to the flexible sealing gasket surrounding the porthole opening or another elastomeric element such as a bumper or stop in such a way that it seems that the porthole door is latched in a close position when it is not. Having a porthole door to an incubator in a closed, but unlatched position presents a risk that the porthole door will be inadvertently opened and put a neonate at risk. For example, the neonate could fall out of the incubator if the porthole door is accidentally opened, or the neonate may be insufficiently protected from impacts or from outside environmental conditions. In addition, some incubator systems include latches on the porthole doors that could be inadvertently moved to an unlatched state by a caregiver by applying a force in a single direction, such as by brushing against the latch. If this were to occur when the incubator cover is installed, the caregiver would not realize the latch was unlatched and the caregivers may inadvertently allow a porthole door to remain unlatched while thinking and behaving as if the porthole door is latched and thus securely closed.

Accordingly, the inventors have developed the current system that helps to prevent a porthole door of an incubator enclosure from remaining stuck in a closed or near-closed position as the rotary latch is moved to the unlatched state. The disclosed neonatal incubator system includes a rotary latch that moves the porthole door away from the sealing gasket or other elastomeric element that is positioned between the porthole door and the side panel, as the latch is moved to the unlatched state. The rotary latch further includes a bias spring that urges the rotary latch back to a latched state to further aide in preventing the inadvertent opening of the rotary latch. In an exemplary embodiment, the porthole door latch is designed to require rotational movement in more than a single direction to move the latch to an unlatched position to reduce the likelihood of inadvertent opening by brushing against the latch. In various embodiments, the rotary latch includes a fluid gutter that restricts the flow of cleaning solutions into the rotary latch to further prevent sticking and damage to the internal components of the rotary latch.

In the above description, certain terms have been used for brevity, clarity, and understanding. No unnecessary limitations are to be inferred therefrom beyond the requirement of the prior art because such terms are used for descriptive purposes and are intended to be broadly construed. The different systems and method steps described herein may be used alone or in combination with other systems and methods. It is to be expected that various equivalents, alternatives and modifications are possible within the scope of the appended claims.

The functional block diagrams, operational sequences, and flow diagrams provided in the Figures are representative of exemplary architectures, environments, and methodologies for performing novel aspects of the disclosure. While, for purposes of simplicity of explanation, the methodologies included herein may be in the form of a functional diagram, operational sequence, or flow diagram, and may be described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology can alternatively be represented as a series of interrelated states or events, such as in a state diagram. Moreover, not all acts illustrated in a methodology may be required for a novel implementation.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

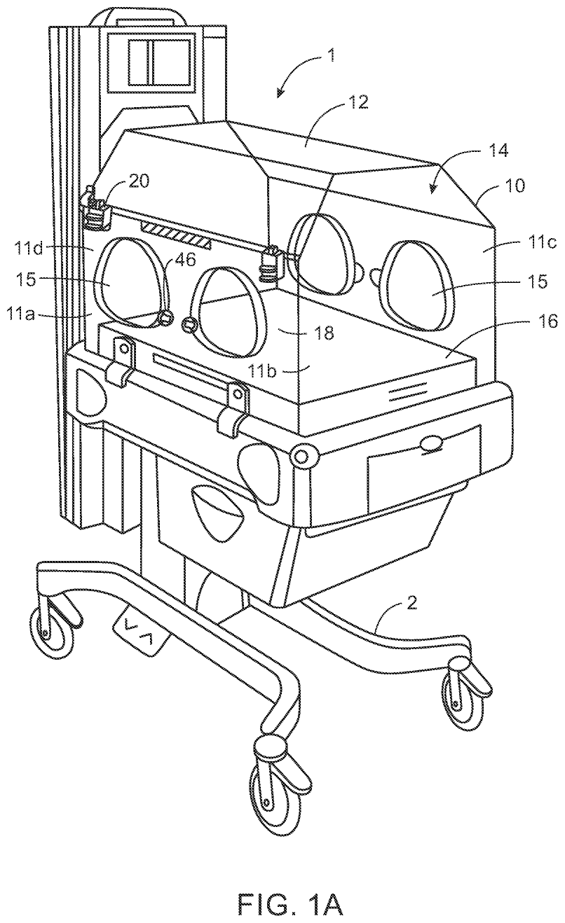

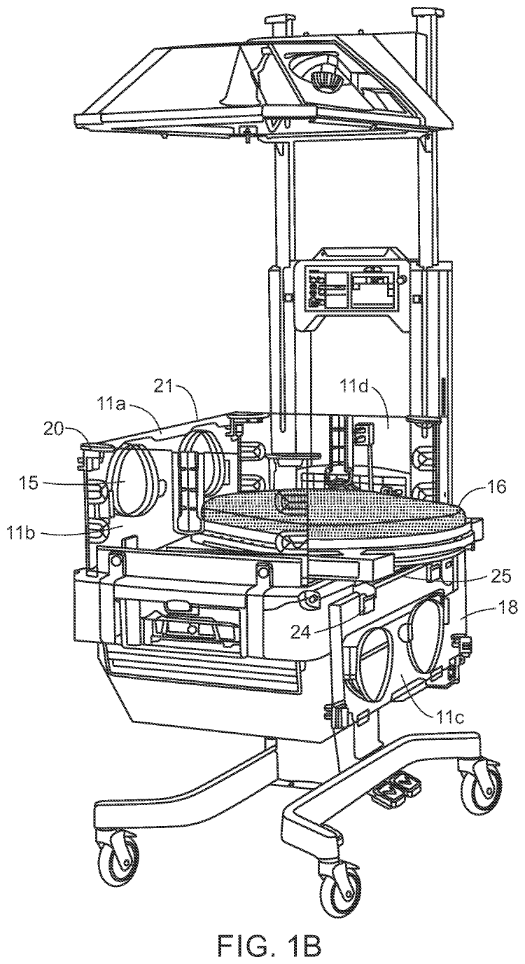

FIG. 1A depicts one embodiment of an incubator system having an enclosure 10 with a rotary latch of the present disclosure. As will be understood by a person having ordinary skill in the art, the disclosed system and method may be implemented on various types of incubator systems, including incubator/warmer systems and radiant warmer systems having enclosures with movable side panels operable to insert and remove a neonate from a controlled environment enclosable to secure the neonate within an area on the platform 16. The term incubator should be interpreted to cover these various types of incubator systems.

The depicted incubator system 1 includes a base 2 that supports a platform 16 configured for receiving and supporting a neonate. In the depicted embodiment, the base 2 includes a horizontal section comprising a pair of u-shaped horizontal members joined together and providing support for a vertical base member extending upward toward the platform 16. The base 2 may include wheels to provide for ready movement of the incubator system 1. A platform 16 is supported on the vertical base member, which may be a standard platform for supporting a neonate, such as configured to receive a removable mattress or other sleep surface.

The incubator system 1 includes an enclosure 10 defining a chamber 14 creating a microenvironment for housing a neonate. The enclosure 10 may be, for example, a transparent housing extending above the platform 16. The enclosure 10 creates and defines a chamber 14 providing a microenvironment, which is an area around the neonate where temperature, humidity, and other environmental factors can be controlled.

The enclosure 10 includes multiple side walls 11a-11d and a top portion 12. For example, the side walls 11a-11d and/or the top portion 12 of the enclosure 10 may be made of a transparent plastic material, as is standard in the relevant art. In various embodiments, the top portion 12 may be integrated with the side walls 11a-11d. In other embodiments, the top portion 12 may be separable from the side walls 11a-11d of the enclosure 10, as shown in FIG. 1B. In the examples, the enclosure 10 includes a plurality of portholes 15 through which a caregiver may access the neonate within the chamber 14. The incubator system 1 may further include a heater used to control the temperature within the microenvironment of the chamber 14. For example, the chamber heater may be a radiant heating or warming device that heats the air within the chamber 14 to a predefined temperature or within a predefined temperature range. In another embodiment, the heater may comprise a convective or conductive heating device or any other type of controllable heating or warming device. The incubator system 1 may further include a humidifier system controllable to adjust the relative humidity within with the chamber 14. For example, the humidifier may include a device that evaporates water, such as distilled water, to increase the relative humidity of air within the chamber 14.

The enclosure 10 includes one or more movable side panels 18 on a side wall 11a-11d of the enclosure 10. The movable side panel 18 is openable to place a neonate on the platform 16 and closable to secure the neonate within the chamber 14. The movable side panel 18 may be only part of a side wall 11a-11d of the enclosure 10 or may comprise the entirety of the side wall 11a, 11c as shown in the depicted embodiments.

In FIG. 1A, the movable side panel 18 is shown in a fully upright, closed position. FIG. 1B shows the movable side panel 18 in a fully retracted, open position. In certain embodiments exemplified at FIG. 1B, the platform 16 may be configured to slide and/or rotate outward when the movable side panel 18 is open to enable easier access to a neonate and/or to enable easy placement of the neonate on the platform 16. The movable side panel 18 has a top side 21 and a bottom side 25. The movable side panel 18 may attach to the enclosure 10 and/or the platform 16 via one or more hinges 24 allowing the movable side panel 18 to be opened and closed. In other embodiments, the movable side panel may attach to a frame 13 or to a side wall 11a-d via hinges or other connecting means, such as clips, pins, pressure or frictions fits, etc. In the depicted embodiment, two hinges 24 attach to a lower side 25 of the movable side panel 18 such that the movable side panel 18 rotates downward to open and upward to close. In other embodiments, the movable side panel 18 may rotate clockwise and counter-clockwise and one or more hinges 24 may be on a lateral side of the movable side panel 18.

One or more side panel latches are also provided to engage the movable side panel and maintain the side panel in a closed position to secure the neonate within the chamber 14 of the incubator system 1. The side panel latch 20 may be any device or set of devices capable of securing the movable side panel 18 in a closed position, including withstanding at least a predefined amount of force that may push against the movable side panel 18, such as by the neonate and/or by elements within the chamber 14 provided as part of the neonatal care (monitors, medical devices, blankets, etc.).

As can be seen in FIG. 1B, each of the portholes 15 is covered by a porthole door that is movable between an open and a closed position to selectively provide access to the chamber defined by the enclosure. In an embodiment such as shown in FIG. 1A in which the enclosure 10 completely surrounds the chamber 14, the portholes 15 allow a caregiver access to a neonate positioned within the enclosure 10.

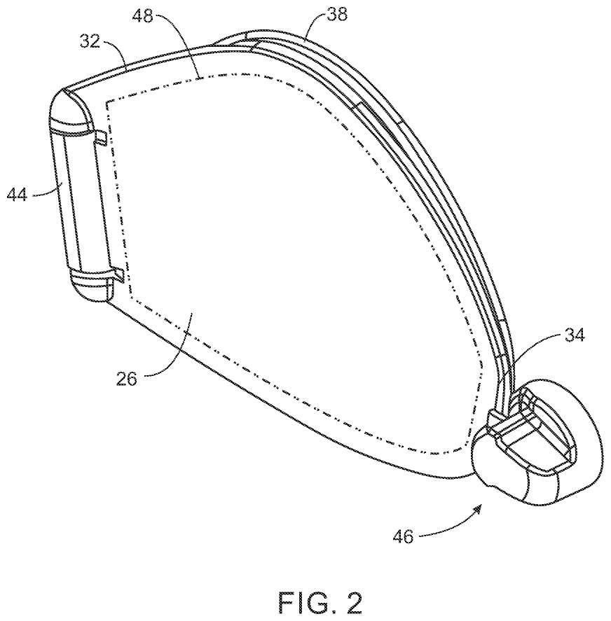

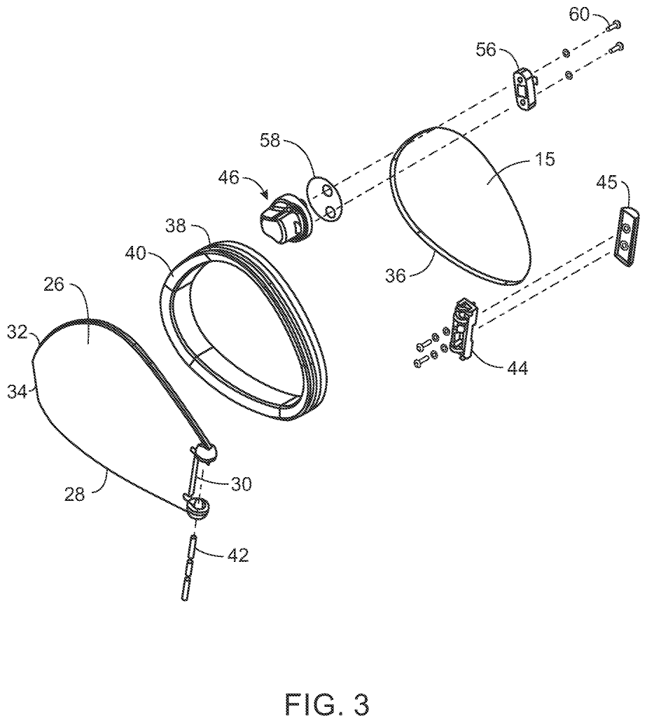

FIGS. 2 and 3 illustrate the configuration of the porthole door 26 and a rotary latch 46 constructed in accordance with the present disclosure that is used to retain the porthole door 26 in a closed condition. As illustrated in FIG. 3, the porthole door 26 is a flat piece of transparent plastic or acrylic material that is defined by an outer edge 28. The porthole door 26 extends from a hinge end 30 to an opposite movement end 32. The movement end 32 includes a flat engagement portion 34 that provides a point of engagement for the rotary latch 46 in a manner to be described below. The porthole 15 is formed in the side panel and is defined by an inner edge surface 36. The inner edge surface 36 defines the overall shape of the porthole 15 and provides a point of connection for a flexible sealing gasket 38. The flexible sealing gasket 38 is preferably formed from a resilient material, such as a rubber or a flexible plastic material. The sealing gasket 38 allows an inner surface of the porthole door 26 to seat against the outer surface 40 of the gasket to create a liquid and gas-tight seal between the porthole door 26 and the sealing gasket 38. Although not shown in the Figures, in some alternate embodiments of the enclosure, flexible elastomeric bumpers or stops can be positioned such that the bumpers are located between the porthole door 26 and the side panel. These bumpers or stops are compressed to cushion the closing of the door and to provide a resilient force to urge the porthole door open.

The hinge end 30 of the porthole door 26 is connected to the outer surface of the side panel through a hinge mechanism that includes pivot pins 42 entrapped between an outer pivot bracket 44 and an inner pivot bracket 45. The inner and outer pivot brackets 44, 45 are positioned on opposite sides of the acrylic side panel. The outer bracket 44 receives the pivot pins 42 and allows the porthole door 26 to pivot between the open and closed positions.

Referring now to FIG. 2, the pivot door 26 is held in the closed position shown by use of the rotary latch 46 constructed in accordance with the present disclosure. The rotary latch 46 engages the engagement portion 34 of the porthole door 26 to hold the porthole door 26 in the closed position shown. As illustrated by the dashed line in FIG. 2, when the porthole door 26 is in the closed position, the sealing gasket 38 engages the inner surface of the porthole door 26 along the dashed line 48. When the rotary latch 46 is in the latched position shown in FIG. 2, the rotary latch 46 prevents the porthole door 26 from opening.

As will be described in greater detail below, the rotary latch 46 can be moved from the latched position shown in FIG. 2 to an unlatched position in which the engagement portion 34 of the porthole door 26 can move away from the side panel to provide access to the open chamber defined by the enclosure. Thus, before a caregiver can access the open interior of the enclosure, the rotary latch 46 must first be moved to the unlatched position and the porthole door 26 swung open.

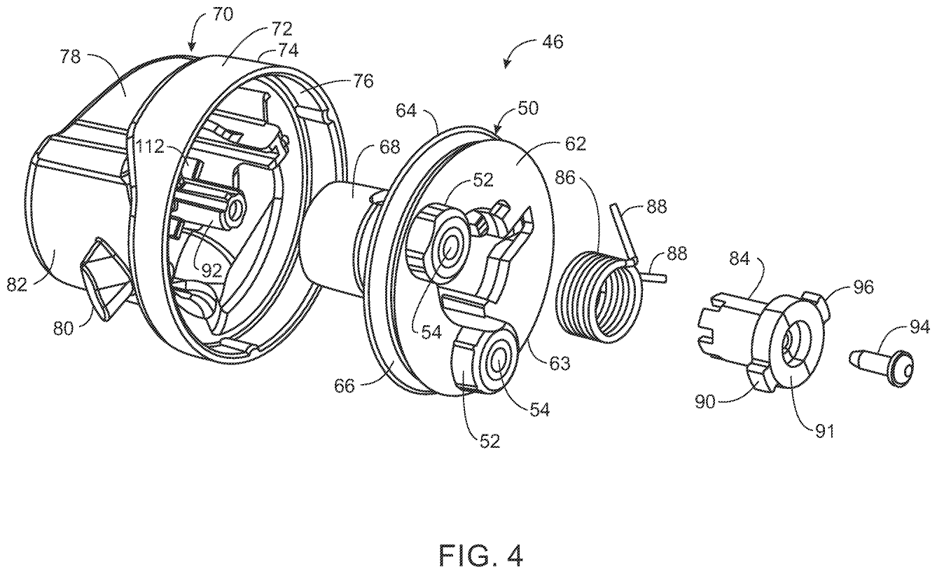

FIG. 4 is an exploded view of the rotary latch 46 constructed in accordance with the exemplary embodiment of the present disclosure. Although an exemplary embodiment of the rotary latch 46 is shown in FIG. 4, it should be understood that the specific configuration of the rotary latch 46 could vary while operating within the scope of the present disclosure.

The rotary latch 46 generally includes a base 50 that is designed to be stationary and securely mounted to the side panel of the enclosure. The base 50 includes a pair of attachment bosses 52 that are sized to extend through corresponding openings formed in the side panel of the enclosure. Each of the attachment bosses 52 includes a connector opening 54 that is internally threaded and sized to receive a connector 60 to secure the base 50 to an attachment bracket 56 located on the opposite side of the side panel, as can be understood in FIG. 3. A flexible gasket 58 can be positioned between the base and the side panel to provide resilient mounting of the base to the side panel. The connectors 60 shown in FIG. 3 secure the base 50 to the side panel such that the base 50 is stationary during operation of the rotary latch 46.

Referring back to FIG. 4, the base 50 includes a generally flat contact surface 62 that either directly contacts the outer surface of the side panel or entraps the gasket between the side panel and the contact surface 62. The contact surface 62 is defined by an outer edge 63 that defines the outer diameter of the contact surface 62. The base 50 further includes an engagement edge 64 that is spaced from the outer edge 63 of the contact surface 62. The space between the engagement edge 64 and the outer edge 63 of the contact surface 62 defines a fluid gutter 66. The fluid gutter 66 is formed as a curved surface that is spaced radially inward from both the engagement edge 64 and the outer edge 63 of the contact surface 62. The fluid gutter 66 is designed to prevent the passage of cleaning fluids and other contaminants from the smooth surface of the side panel into the operating components of the rotary latch 46.

The base 50 further includes an attachment portion 68 that extends away from the engagement edge 64. The attachment portion 68 is designed to provide rotating support for a control knob 70 that forms another part of the rotary latch 46. The control knob 70 shown in FIG. 4 provides the user engagement portion of the rotary latch 46, such as when being operated by a caregiver to open or close the porthole door. The control knob 70 includes a skirt 72 having an outer diameter defined by an outer surface 74 and an inner surface 76. The diameter of the inner surface 76 of the skirt 72 is selected to closely correspond to the outer diameter of the engagement edge 64 of the base 50 to help restrict the passage of fluid and other contaminants past the engagement edge 64.

The skirt 72 depends from the main body 78 of the control knob. The main body 78 provides a point of engagement for a caregiver to rotate the control knob 70 relative to the stationary base 50 in a manner to be described in greater detail below. As shown in FIG. 4, a locking tab 80 extends away from a front surface 82 of the main body 78.

The rotary latch 46 further includes a spring case 84 and a bias spring 86 that are used to create a bias force between the control knob 70 and the base 50. In the embodiment shown, the bias spring 86 is a torsion spring having a pair of spring ears or ends 88 that engage internal components and mounting tabs within the control knob 70 to bias the control knob 70 into a home position. The bias spring 86 provides a bias force against rotation of the control knob 70 in either a clockwise or a counterclockwise direction such that the control knob 70 is biased to a home, latched position such as is shown in FIG. 2. Rotation of the rotary latch 46 in either direction will compress the bias spring 86 such that when the control knob 70 is released, the bias spring 86 causes the control knob 70 to return to the home, latched position shown in FIG. 2.

Referring back to FIG. 4, the spring case 84 is an injection molded plastic component and includes a pair of ears 90 on a lower rim 91. The spring case 84 is secured to an attachment boss 92 formed in the interior of the control knob 70 by a connector 94. In this manner, the spring case 84 is securely connected to the control knob 70 and moves with the control knob 70. The pair of ears 90 are positioned within the base 50 and engage a pair of shoulders in the base. When the ears 90 move off of the support shoulders in the base 50, the control knob 70 and the spring case 84 can move away from the stationary base 50 for cleaning. In this manner, the entire control knob 70 can move away from the stationary base 50 to allow for cleaning between the control knob 70 and the side panel as will be described in much greater detail below.

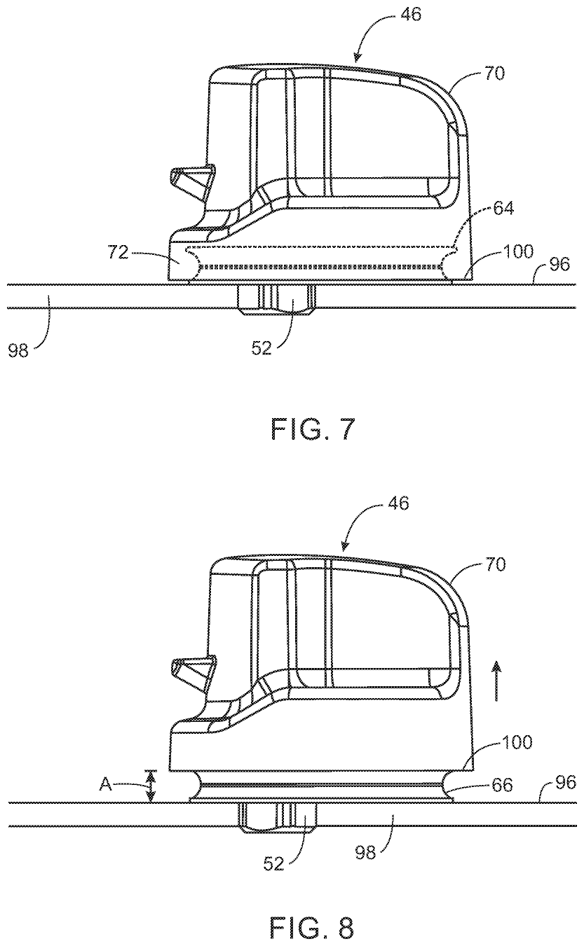

As indicated above, the rotary latch 46 of the present disclosure is designed such that the control knob 70 can move away from the base 50 for cleaning operations. During cleaning, cleaning materials are sprayed on the side panels of the enclosure and the cleaning materials run along the outer surface of the side panel through gravity. As shown in FIG. 7, the outer surface 96 of the side panel 98 is generally flush with a lower edge 100 of the skirt 72 of the control knob 70. The slight space between the lower edge 100 and the outer surface 96 allows debris, liquid and other undesirable materials to become entrapped between the control knob 70 and the side panel 98. In accordance with the present disclosure, the rotary latch 46 is designed to allow the control knob 70 to move slightly upward to create a gap A between the lower edge 100 and the outer surface 96 of the side panel 98 as shown in FIG. 8. The gap A exposes the fluid gutter 66 and allows a caregiver to clean the debris and material from the fluid gutter 66. As discussed previously, the engagement edge 64 that defines the upper portion of the fluid gutter 66 closely interacts with the inner surface of the skirt 72 to prevent debris and fluid from entering into the open area defined by the control knob 70.

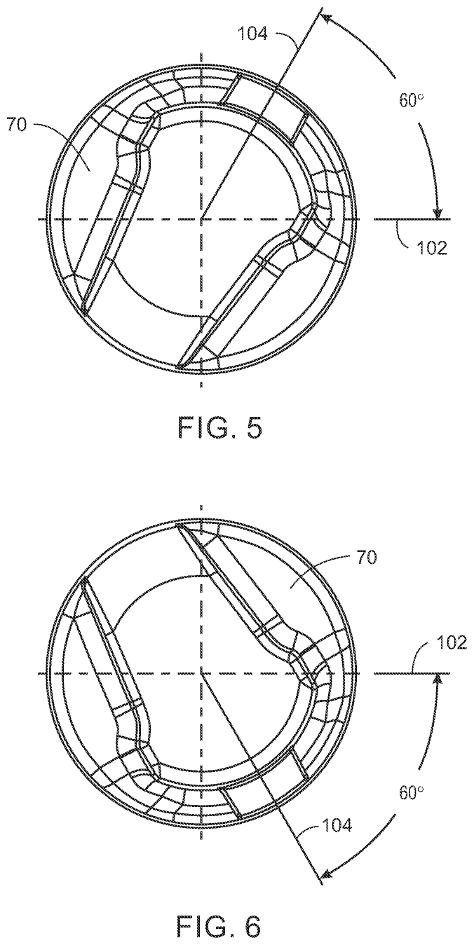

Referring now to FIGS. 5 and 6, the rotary latch 46 enters into the cleaning position by rotating the control knob 70 either clockwise, as shown in FIG. 6, or counterclockwise as shown in FIG. 5 from a home position indicated by reference line 102. In the embodiment illustrated in FIGS. 5 and 6, the amount of rotation needed to reach the cleaning position is approximately 60° although this value could vary depending on design choice. When the control knob 70 is in this position, the ears 90 on the spring case 84 align with internal slots formed in the base to allow the control knob 70 and the connected spring case 84 to move as illustrated in FIGS. 7 and 8. During any amount of rotational movement of the control knob 70 less than to the cleaning position shown by lines 104 in FIGS. 5 and 6, the ears 90 will not align with the slots formed in the base and thus the control knob 70 will not be able to move upward as illustrated in FIG. 8. The rotary latch 46 is designed such that the rotation to the cleaning position shown by line 104 in FIGS. 5 and 6 is greater than the amount of rotation required to move the rotary latch 46 from the latched position to the unlatched position. As an illustrative example, the rotary latch 46 is designed to open upon 40° of rotation while the cleaning position requires 60° of rotation. Thus, the rotary latch can only be moved into the cleaning position shown in FIGS. 5 and 6 after the porthole door has been opened after the rotary latch has moved past the unlatched position.

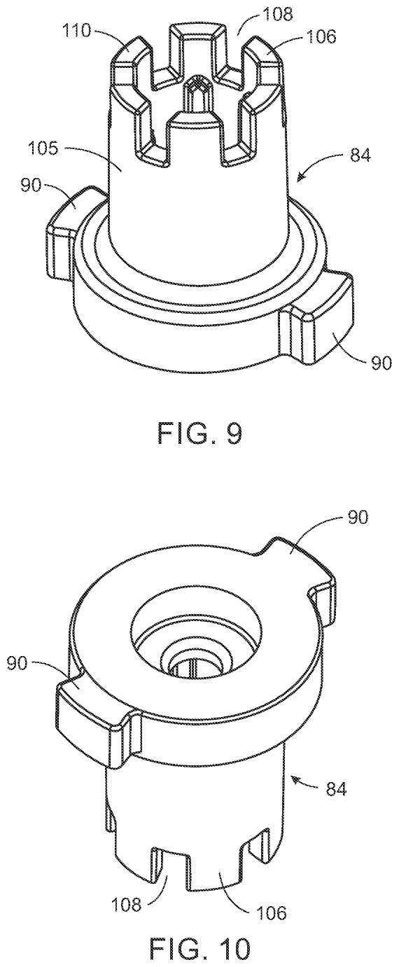

FIGS. 9 and 10 show a more detailed view of the spring case 84 constructed in accordance with the present disclosure. In the embodiment illustrated, the spring case 84 is a molded plastic component that includes an attachment barrel 105 having a plurality of teeth 106 and slots 108 near its outer end 110. The slots 108 receive corresponding tabs 112 formed on the interior of the control knob 70 as was shown in FIG. 4. The interaction between the tabs 112 and the slots 108 prevent relative rotation between the spring case 84 and the control knob 70 when the rotary latch 46 is assembled.

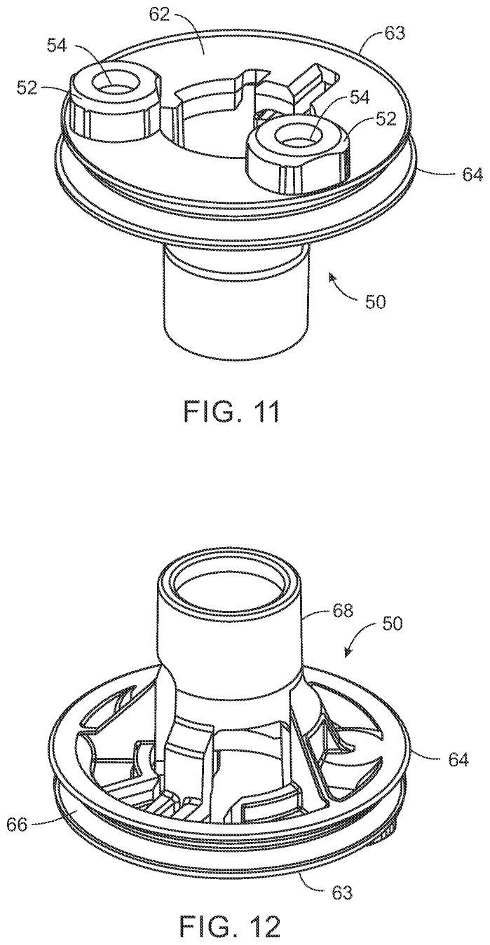

FIGS. 11-13 provide additional views of the base 50 constructed in accordance with the present disclosure. As with the spring case, the entire base 50 is formed as an injection molded plastic component that is formed as a one-piece structure. The base 50 defines the fluid gutter 66 between the engagement edge 64 and the outer edge 63 of the contact surface 62. A pair of attachment bosses 52 extend through the side panel 98 as is best shown in FIGS. 7 and 8.

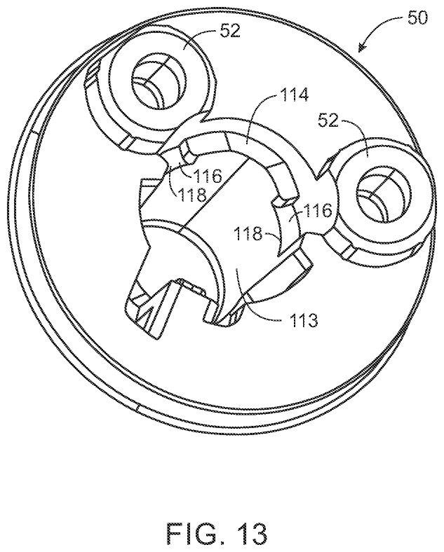

Referring now to FIG. 13, the interior of the base 50 includes a smooth inner wall 113 having an inner diameter sized to correspond to the outer diameter of the spring case such that the spring case can rotate within the base 50. The inner wall 113 is defined at a lower end by a support shoulder 114 that is sized to contact and support the ears on the spring case during normal rotating movement of the control knob. The length of the support shoulder 114 is selected such that during the rotation of the control knob between the latched and unlatched positions, the ears of the spring case remain in contact with the support shoulder 114. When the control knob rotates further to the cleaning positions shown by lines 104 in FIGS. 5 and 6, the ears formed on the spring case 84 become aligned with recessed slots 116 located on each side of the support shoulder 114. The recessed slots 116 are defined at an inner end by a stop surface 118 that is spaced from the support shoulder 114. Thus, when the control knob is rotated such that the ears on the spring case 84 align with the pair of slots 116, the control knob can be lifted away from the base until the ears contact the stop surfaces 118. The stop surfaces thus define and limit the amount of movement between the control knob 70 and the base 50 as shown in FIG. 8.

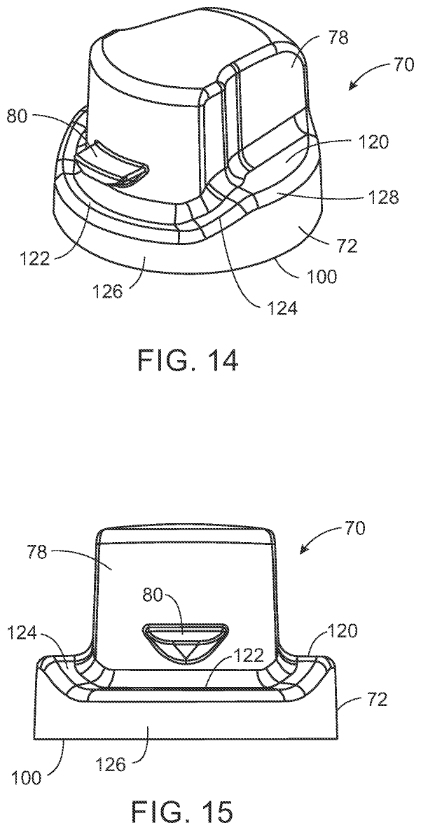

FIGS. 14 and 15 show the specific configuration of the control knob 70 of the exemplary embodiment of the present disclosure. As discussed previously, the control knob 70 is an injection molded plastic component that includes the skirt 72 and the main body 78. The locking tab 80 extends radially outward from the main body 78. The skirt 72 is defined at a top end by a top surface 120 and at the bottom end by the lower edge 100. The top surface 120 has a varying height from the lower edge 100 of the control knob 70 around the outer circumference of the control knob 70. The lowest point of the top surface is aligned with the locking tab and will be referred to as the contact surface 122. On each end of the contact surface 122, as best shown in FIG. 15, is a sloped movement surface 124. The movement surface 124 is the portion of the top surface 124 that transitions from the contact surface 122 to the top surface 120. As can be seen in FIG. 14, the thickness of the skirt 72 increases from the front edge 126 which is aligned with the locking tab 80 to a position 128. The movement surfaces 124 create the smooth transition from the contact surface 122 to the top surface 120.

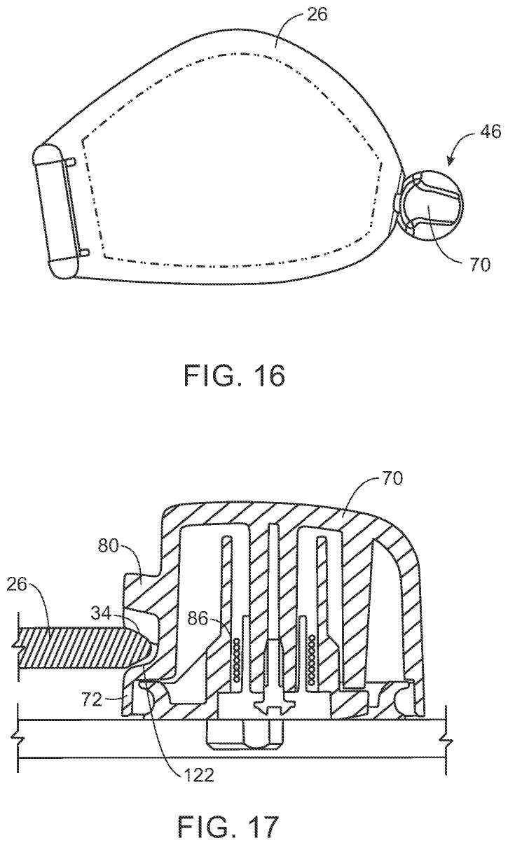

Referring now to FIGS. 16 and 17, the rotary latch 46 is shown in its latched position and the porthole door 26 is in the closed position. In the closed position, the sealing gasket surrounding the porthole creates a fluid and airtight seal with the inner surface of the porthole door 26. In alternate embodiments of the enclosure that include elastomeric bumpers or stops, the bumpers would be compressed when the porthole door 26 is in the closed position and the rotary latch is in the latched position. As can be seen in the section view of FIG. 17, the engagement portion 34 of the porthole door 26 is entrapped between the locking tab 80 and the contact surface 122 of the skirt 72. The bias spring included in the rotary latch 46 exerts a bias force on the control knob 70 to hold the control knob in the latched position shown in FIGS. 16 and 17. In this position, even if the control knob 70 is unintentionally contacted by a caregiver, the bias spring 86 will exert enough force against the linear force unintentionally applied by the caregiver to return the control knob 70 to the latched position shown. The rotary latch is designed to require a rotating opening force in more than one direction to help reduce inadvertent opening of the rotary latch.

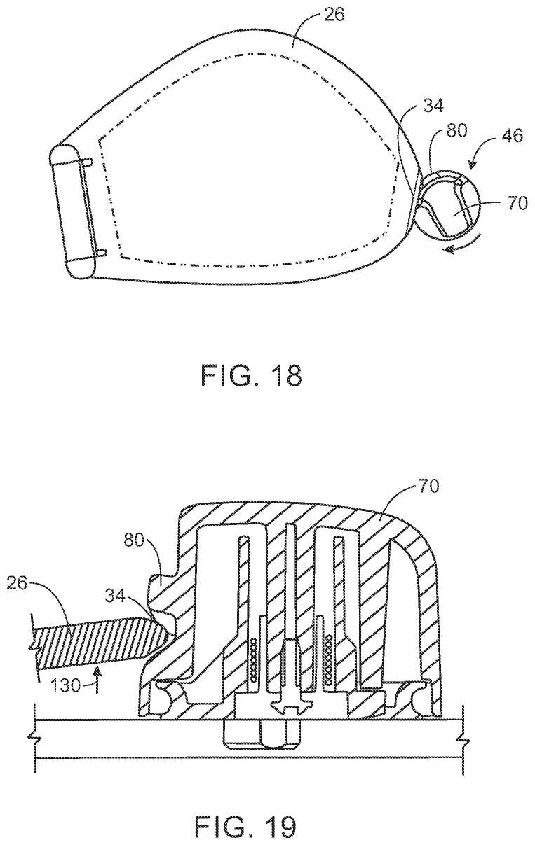

Referring now to FIGS. 18 and 19, when a caregiver wishes to open the porthole door 26, the caregiver grasps the control knob 70 and rotates the control knob 70 either in the clockwise direction shown in FIG. 18 or in a counterclockwise direction. The control knob 70 is designed such that once the control knob 70 has rotated approximately 40° in either the counterclockwise or clockwise direction, the engagement portion 34 of the porthole door is no longer entrapped beneath the locking tab 80 and the porthole door 26 can be moved from the closed position shown to an open position.

As the control knob 70 is rotated from the latched position shown in FIG. 16 to the unlatched position shown in FIG. 18, the engagement portion 34 of the porthole door 26 travels along the upwardly sloped movement surface 124, which is best shown in FIGS. 13 and 14. Since the movement surface 124 transitions between the contact surface 122 and the top surface 120, during the rotation of the control knob 70 in either the clockwise or counterclockwise direction, the entire porthole door 26 is caused to move upward as shown by arrow 130 in FIG. 19. This forced, upward movement of the porthole door 26 creates separation between the inner surface of the porthole door and the sealing gasket 38. In alternate embodiments, the movement of the porthole door 26 away from the side panel will separate the porthole door 26 from elastomeric bumpers or stops located between the porthole door 26 and the side panel. Thus, when the rotary latch 46 is moved to the unlatched position, the movement of the control knob 70 creates positive separation between the porthole door 26 and the sealing gasket or other elastomeric elements located between the porthole door and the side panel. Such positive separation reduces the risk that the porthole door 26 remain in what appears to be a closed position even when the rotary latch 46 is in an unlatched condition.

In addition to creating positive separation of the porthole door 26 from the sealing gasket during movement of the control knob as the rotary latch 46 moves from the latched position to the unlatched position, the configuration of the movement surface 124 works in the reverse when the rotary latch 46 is moved back to the latched position. Specifically, when the porthole door 26 is closed, the rotary latch 46 must be rotated away from the home position created by the bias spring. Once the locking tab 80 is rotated away, the porthole door 26 can be closed. In the initial closed position, such as shown in FIG. 19, the porthole door 26 contacts the top surface of the control knob. The control knob is then rotated toward the latched position. During this movement, the porthole door 26 is forced into contact with the sealing gasket to help create the fluid and airtight seal.

As discussed above, the inventors have recognized a problem with existing incubator systems, including incubator/warmer systems, where the porthole door to the incubator can be in a closed but unsecured position where the door appears to be latched but is not. Accordingly, the inventors have developed the disclosed solution that includes a rotary latch for use on each of the porthole doors to force the movable porthole door out of a position where it appears latched but is not. Namely, the rotary latch prevents the movable porthole door from being in a near-closed position or a fully closed position when the rotary latch is not engaged.

We claim:

1. A neonatal incubator system for use with an infant comprising:
an enclosure configured to create a chamber around the infant, the enclosure including:
a plurality of side panels;
at least one porthole formed in one of the plurality of side panels;
a porthole door associated with each of the portholes, the porthole door being movable between a closed position and an open position;
a rotary latch movable between a latched position in which the rotary latch secures the porthole door in the closed position and an unlatched position in which the porthole door is movable to the open position,
wherein when the rotary latch rotates from the latched position to the unlatched position, the rotary latch contacts the porthole door and moves the porthole door away from the closed position.

2. The system of claim 1 wherein the rotary latch includes a bias spring that biases the rotary latch toward the latched position.

3. The system of claim 2 wherein the rotary latch is rotatable in both a clockwise direction and a counterclockwise direction from the latched position to one or more unlatched positions.

4. The system of claim 1 wherein the rotary latch includes a control knob having a contact surface and a locking tab, wherein an engagement portion of the porthole door is held between the contact surface and the locking tab when the rotary latch is in the latched position and the porthole door is in the closed position.

5. The system of claim 4 wherein the control knob includes a sloped movement surface extending away from the contact surface on each end of the contact surface, wherein the movement surface contacts the engagement portion of the porthole door to move the porthole door away from the closed position as the rotary latch moves from the latched position to the unlatched position.

6. The system of claim 1 wherein the rotary latch includes a base having a contact surface that contacts the side panel and a control knob that is received on the base, wherein the control knob is rotatable about the base.

7. The system of claim 6 wherein the control knob is movable away from the base and the side panel.

8. The system of claim 7 wherein the control knob is movable away from the base and the side panel when the control knob is rotated to a cleaning position.

9. The system of claim 8 wherein the control knob is rotated past the unlatched position to reach the cleaning position.

10. The system of claim 6 wherein the base includes a fluid gutter extending between the contact surface and an engagement edge that contacts the control knob.

11. The system of claim 6 further comprising a bias spring positioned between the base and the control knob, wherein the bias spring biases the control knob toward the latched position.

12. A neonatal incubator system for use with an infant comprising:
an enclosure configured to create a chamber around the infant, the enclosure including:
a plurality of side panels;
at least one porthole formed in one of the plurality of side panels;
a porthole door associated with each of the portholes, the porthole door being movable between a closed position and an open position;
a rotary latch movable between a latched position in which the rotary latch secures the porthole door in the closed position and an unlatched position in which the porthole door is movable to the open position, the rotary latch including:
a base having a contact surface that contacts the side panel;
a control knob that is received on the base, wherein the control knob is rotatable about the base between the latched and unlatched positions; and
a bias spring positioned between the base and the control knob to bias the control knob toward the latched position,
wherein when the rotary latch rotates from the latched position to the unlatched position, the rotary latch contacts the porthole door and moves the porthole door away from the closed position.

13. The system of claim 12 wherein the control knob is movable away from the base and the side panel when the control knob is rotated to a cleaning position.

14. The system of claim 13 wherein the control knob is rotated past the unlatched position to reach the cleaning position.

15. The system of claim 12 wherein the control knob includes a contact surface and a locking tab, wherein an engagement portion of the porthole door is held between the contact surface and the locking tab when the rotary latch is in the latched position and the porthole door is in the closed position.

16. The system of claim 15 wherein the control knob includes a sloped movement surface extending away from the contact surface on each end of the contact surface, wherein the movement surface contacts the engagement portion of the porthole door to move the porthole door away from the closed position as the rotary latch moves from the latched position to the unlatched position.

17. A rotary latch for use with a neonatal incubator system for use with an infant including an enclosure configured to create a chamber around the infant having a plurality of side panels having at least one porthole and an associated porthole door movable between a closed position and an open position, the rotary latch comprising:
a base having a contact surface that contacts the side panel;
a control knob that is received on the base, wherein the control knob is rotatable about the base between a latched position and an unlatch position; and
a bias spring positioned between the base and the control knob to bias the control knob toward the latched position,
wherein when the rotary latch rotates from the latched position to the unlatched position, the rotary latch is configured to contact the porthole door and move the porthole door away from the closed position.

18. The rotary latch of claim 17 wherein the control knob includes a contact surface and a locking tab, wherein an engagement portion of the porthole door is held between the contact surface and the locking tab when the control knob is in the latched position and the porthole door is in the closed position.

19. The rotary latch of claim 18 wherein the control knob includes a sloped movement surface extending away from the contact surface on each end of the contact surface, wherein the movement surface contacts the engagement portion of the porthole door to move the porthole door away from the closed position as the rotary latch moves from the latched position to the unlatched position.

20. The rotary latch of claim 17 wherein the control knob is movable away from the base and the side panel when the control knob is rotated to a cleaning position.

21. The rotary latch of claim 17 wherein the base includes a fluid gutter extending between the contact surface and an engagement edge that contacts the control knob.
